(19) United States
(12) Patent Application Publication
(10) Pub. No.: US 2015/0222146 A1
(43) Pub. Date: Aug. 6, 2015

(54) SYSTEMS AND METHODS FOR UNINTERRUPTIBLE POWER SUPPLIES WITH GENERATORS

(71) Applicant: IDEAL POWER INC., Austin, TX (US)

(72) Inventor: William C. Alexander, Spicewood, TX (US)

(73) Assignee: IDEAL POWER INC., Austin, TX (US)

(21) Appl. No.: 14/678,363

(22) Filed: Apr. 3, 2015

Related U.S. Application Data
(63) Continuation of application No. 14/265,300, filed on Apr. 29, 2014.
(60) Provisional application No. 61/817,019, filed on Apr. 29, 2013.

(51) Int. Cl. H02J 9/06

(52) U.S. Cl. CPC H02J 9/061

(57) ABSTRACT

Systems and methods where a power-packet-switching converter is used to interface a synchronous AC connection (e.g. to the utility power grid, or to a microgrid) to a DC source (e.g. a battery bank, or possibly a photovoltaic cell bank) and to a non-synchronous AC power source (e.g. a wind turbine or a motor-generator). The power-packet-switching converter not only provides voltage conversion and other functions (e.g. DC to AC, AC-AC with frequency change, 2-phase to 3-phase, power factor correction etc.), but also provides phase correction to convert asynchronous AC to synchronous AC.

### CROSS-REFERENCE

Priority is claimed from 61/817,019 filed Apr. 29, 2013, which is hereby incorporated by reference.

### BACKGROUND

The present application relates to power converters, and more specifically, to multi-port power converters providing an uninterruptible power supply (UPS) for a microgrid, with battery and generator inputs.

Note that the points discussed below may reflect the hindsight gained from the disclosed inventions, and are not necessarily admitted to be prior art.

A new kind of power converter was disclosed in U.S. Pat. No. 7,599,196 entitled “Universal power conversion methods,” which is incorporated by reference into the present application in its entirety. This patent describes a bidirectional (or multidirectional) power converter which pumps power into and out of a link inductor which is shunted by a capacitor.

The switch arrays at the ports are operated to achieve zero-voltage switching by totally isolating the link inductor+capacitor combination at times when its voltage is desired to be changed. (When the inductor+capacitor combination is isolated at such times, the inductor's current will change the voltage of the capacitor, as in a resonant circuit. This can even change the sign of the voltage, without loss of energy.) This architecture has subsequently been referred to as a “current-modulating” or “Power Packet Switching” architecture. Bidirectional power switches are used to provide a full bipolar (reversible) connection from each of multiple lines, at each port, to the rails connected to the link inductor and its capacitor. The basic operation of this architecture is shown, in the context of the three-phase to three-phase example of patent FIG. 3, in the sequence of drawings from patent FIG. 12a to patent FIG. 12j.

The ports of this converter can be AC or DC, and will normally be bidirectional (at least for AC ports). Individual lines of each port are each connected to a “phase leg,” i.e. a pair of switches which permit that line to be connected to either of two “rails” (i.e. the two conductors which are connected to the two ends of the link inductor). It is important to note that these switches are bidirectional, so that there are four current flows possible in each phase leg: the line can source current to either rail, or can sink current from either rail.

Many different improvements and variations are shown in the basic patent. For example, variable-frequency drive is shown (for controlling a three-phase motor from a three-phase power line), DC and single-phase ports are shown (patent FIG. 21), as well as three- and four-port systems, applications to photovoltaic systems (patent FIG. 23), applications to Hybrid Electric vehicles (patent FIG. 24), applications to power conditioning (patent FIG. 29), half-bridge configurations (patent FIGS. 25 and 26), systems where a transformer is included (to segment the rails, and allow different operating voltages at different ports) (patent FIG. 22), and power combining (patent FIG. 28).

Improvements and modifications of this basic architecture have also been disclosed in U.S. Pat. Nos. 8,391,033, 8,295,069, 8,531,858, and 8,461,718, all of which are hereby incorporated by reference.

The term “converter” has sometimes been used to refer specifically to DC-to-DC converters, as distinct from DC-AC “inverters” and/or AC-AC frequency-changing “cycloconverters.” However, in the present application the word converter is used more generally, to refer to all of these types and more, and especially to converters using a current-modulating or power-packet-switching architecture.

There are many different configurations for power conversion systems, which allow different current conversions such as direct current to direct current (DC to DC), alternating current to alternating current (AC to AC), DC to AC, and DC to AC. Typically, power conversion systems include an inverter, which is a device capable of performing such conversions. In the current state of the art, a typical configuration for an inverter includes a transformer as a main component for current conversion. However, transformers tend to be large and heavy, increasing installation costs and space requirements. Furthermore, advanced inverter designs for single-port and multi-port power conversion systems include capacitors and inductors, in order to filter harmonic periods and allow desired conductive periods to be transferred to an output.

Bidirectional multi-port power conversion systems are convenient for storing electricity on a large scale within an electrical power grid. For example, when electricity production exceeds consumption in a power grid, the remaining electrical energy can be stored in batteries for later use. On the other hand, when consumption exceeds production, the energy from these batteries can be used to supply or supplement the power demand from the grid.

Engine-driven generators (Gen-Sets) and battery banks under the current art are usually used to provide a continuous power supply. However, refueling and maintenance costs become significant over time. In order to reduce such costs, renewable energy, such as photovoltaic power, can be used as the primary power sources, while diesel gen-sets can be used as secondary power sources. Excess energy generated by the primary or secondary power sources (i.e., energy not consumed by a load) can be used to charge a battery bank configured to store electric energy for backup use. Typically, it is preferred to generate a high percentage of energy with the renewable power sources.

In order to supply power to an AC utility grid, synchronous alternating current (AC) needs to be achieved in a power conversion system. The state of the current art proposes complicated solutions such as doubly fed asynchronous generators (DFAG) with variable frequency power electronic inverters. Some methods include a rectifier in order to transform the AC to direct current (DC) and subsequently connecting the DC to an inverter in order to transform the DC to synchronous AC.

A second approach from the state of the current art includes topologies with multiple bidirectional power conversion modules, each of these modules including multiple portals such as DC ports for storage purposes, however, these topologies have more than one power conversion module and therefore, efficiency is decreased in the process.

There is a need for an effective multi-port converter with a single power conversion stage in accordance with the aforementioned functions.

### Systems and Methods for Uninterruptible Power Supplies with Generators

The present application discloses variously (in some but not necessarily all embodiments) that a power-packet-switching converter can be used to interface a synchronous AC connection (e.g. to the utility power grid, or to a microgrid) to a DC source (e.g. a battery bank, or possibly a photovoltaic cell bank) and to a non-synchronous AC power source (e.g. a wind turbine or a motor-generator). The power-packet-switching converter not only provides voltage conversion and other functions (e.g. frequency change in some embodiments), but also provides phase correction to convert asynchronous AC to synchronous AC.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 shows a schematic view for a Gen-set application, in accordance with an exemplary embodiment.

FIG. 2 shows a bidirectional 3-port power conversion system, in accordance with the present disclosure.

FIG. 3 shows a schematic view of a Gen-set-backed uninterruptible power supply, in accordance with the prior art.

FIG. 4 shows a schematic view for an AC Gen-set with microgrid applications, in accordance with an exemplary embodiment.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The present application discloses new approaches to using a multi-port power conversion system in a uninterruptible power supply (UPS)/Micro-grid with battery and generator inputs.

The disclosed innovations, in various embodiments, provide one or more of at least the following advantages. However, not all of these advantages result from every one of the innovations disclosed, and this list of advantages does not limit the various claimed inventions.
Lower cost and simpler electrical circuit to implement.
Less bulk and weight with fewer electrical components.
Greater reliability and efficiency.

Some exemplary parameters will be given to illustrate the relations between these and other parameters. However it will be understood by a person of ordinary skill in the art that these values are merely illustrative, and will be modified by scaling of further device generations, and will be further modified to adapt to different materials or architectures if used.

The present disclosure provides a multi-port power conversion system coupled to an AC generator and DC generator or storage system in order to provide power to an AC grid or microgrid. In one or more aspects of the present inventions, bidirectional multi-port power conversion systems can allow support for multiple independent DC and AC ports in one single-power conversion stage, therefore increasing power generation efficiency and reducing costs. In another aspect of the present disclosure, a three-port AC Gen-set and DC generator/storage converter can eliminate the power electronics related inefficiency and cost penalties of integrating AC and DC generation/storage devices.

The multiport power converter can allow transforming asynchronous AC to synchronous AC, while also converting AC to DC in one single step, thereby eliminating the need of additional power conversion stages. Furthermore, the proposed three-port topology can allow storing energy generated by a gen-set into a bank of battery coupled to a port to use during peak demands from a power grid. This can be achieved by transferring and storing generated electricity in a battery port when energy production exceeds energy consumption. Energy can then be retrieved from a bank of batteries connected to the battery port when consumption exceeds production.

In another aspect of the present inventions, a proposed three-port power conversion system can allow optimizing power generation with a fuel generator in a power grid or micro-grid. In yet another aspect of the present inventions, a DC generator/storage or resistor bank device can be used for dynamic braking of an AC generator.

Definitions

“Power converter” refers to electrical or electromechanical devices used for conversion of electric energy from one form into another from an input to an output, including DC to DC, DC to AC, and AC-AC, single and three phases and different voltage levels and frequencies, among other variations.

“Link” refers to a resonant circuit including at least one link inductor and one link capacitor in parallel.

“Soft switching” refers to a zero voltage switching that prevents switching losses and stress when current passes through switches in a power converter.

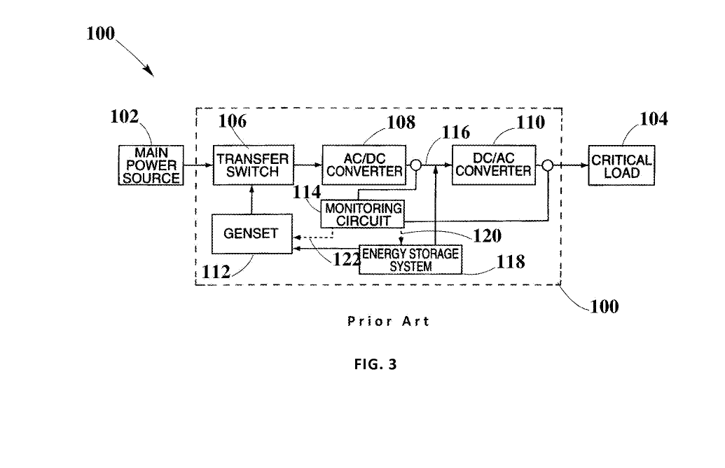

FIG. 3 shows a schematic view of a Gen-set-backed uninterruptible power supply (UPS) 100, in accordance with the prior art (see U.S. Pat. No. 5,767,591). UPS 100 can be connected between a main power source 102, which can be power supplied from a utility company, and critical load 104. Critical load 104 can represent any one of several different applications in which a continuous supply of power is critical, such as airports, hospitals, etc. UPS 100 provides backup power to critical load 104 in the event that main power source 102 fails. UPS 100 can include a transfer switch 106, AC-DC Converter 108, DC-AC converter 110, Gen-set 112, Monitoring Circuit 114, and DC buss 116. UPS 100 can also include energy storage system 118, which is preferably a flywheel energy storage system, but can be a bank of batteries, however, additional circuit modifications (not shown) must be made to step the DC voltage down to 24 volts.

Transfer switch 106 transfers the power supply from main power source 102 to Gen-set 112 after main power source 102 fails and Gen-set 112 is generating power at a sufficient level. AC-DC converter 108 receives the AC power provided by either main power source 102 or Gen-set 112 and converts it to DC power. AC-DC Converter 108 can be a simple rectifier circuit, or it can be any other conventional circuit used to convert power from AC to DC as long as it maintains the proper power levels. This is typically accomplished by providing DC power to DC buss 116 at a level of approximately 480 volts. The DC power is fed across DC buss 116 to DC-AC converter 110, which converts it back to AC power. DC-AC Converter 110 can be a simple inverter circuit, or it can be any other conventional circuit used to convert power from DC to AC.

Monitoring circuit 114 monitors DC buss 116 until the voltage on DC buss 116 drops below a predetermined threshold (monitoring circuit 114 can also be activated by sensor inputs at either the input to AC-DC converter 108, the output to DC-AC converter 110, or both). Once monitoring circuit 114 detects a failure, a trigger signal is applied via line 120 that brings energy storage system 118 online to DC buss 116 and to provide temporary power until Gen-set 112 is optimally functional. The trigger signal also causes energy storage system 118 to provide startup power to Gen-set 112, which is switched on by a trigger signal on line 122. Energy storage system 118 provides startup power to Gen-set 112 until Gen-set 112 is running independently on its external fuel supply (e.g., diesel fuel or gasoline). Once Gen-set 112 is producing power at the proper level, transfer switch 106 transfers the input power from main power source 102 to Gen-set 112 and energy storage system 118 ceases to provide power to DC buss 116.

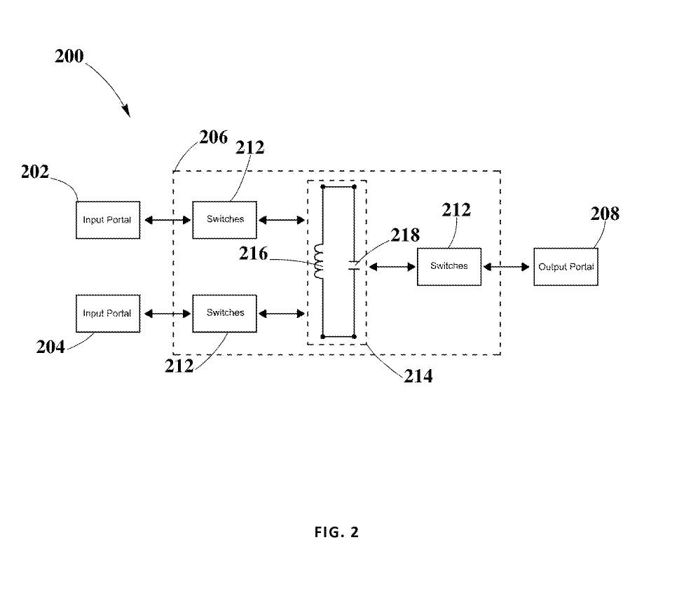

FIG. 2 shows a bidirectional 3-port power conversion system 200, in accordance with the present inventions. 3-port power conversion system 200 can be used to convert energy from first input portal 202 and second input portal 204, passing through a power converter 206 to output portal 208 while adjusting a wide range of voltages, current levels, power factors, and frequencies between portals. According to an exemplary embodiment, first input portal 202 can include an AC generator such as a distributed generator system (i.e., a Gen-set). Second input portal 204 can include a DC generator or storage. Output portal 208 can be a three phase AC port enhanced with an active neutral to support micro-grid functionality.

As depicted, power converter 206 can include different bidirectional switches 212 connected between first input portal 202, second input portal 204, and link 214 to output portal 208. Each bidirectional switches 212 is capable of conducting and blocking current in two directions, and can be composed of bidirectional internal gate bipolar transistors (IGBTs) or other bidirectional switches. Most combinations of bidirectional switches contain two independently controlled gates, with each gate controlling current flow in one direction. Generally, in the embodiments described, when switches are enabled, only the gate that controls current in the desired direction is enabled.

Link 214 can include link inductor 216 and link capacitor 218, connected in parallel with link inductor 216, forming a resonant circuit that can allow for soft switching and flexibility of adjusting link 214 voltage to meet individual needs of first input portal 202, second input portal 204, and output portal 208.

Additionally, link 214 can provide isolation between first input portal 202, second input portal 204, and output portal 208, eliminating the need for a transformer, as well as improving speed of response and reducing acoustic noise in case of frequency being outside audible range.

Furthermore, filter capacitors can be placed between input phases and also between output phases, in order to closely approximate first input portal 202, second input portal 204, and output portal 208, and to attenuate current pulses produced by the bidirectional switches 212 and link inductor 216. An input line reactor can be needed in some applications to isolate the voltage ripple on the input and output filter capacitors. In the disclosed power converter 206, the bidirectional switches 212 can be controlled to convert AC to AC, AD to DC, DC to AC, and DC to DC as it modifies the various input power signals into a desired power signal, such as modifying an asynchronous AC power signal to synchronous AC.

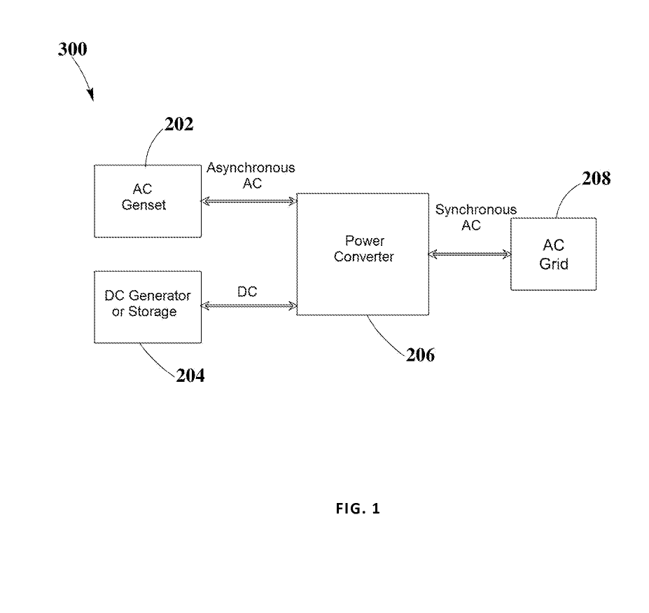

FIG. 1 shows a schematic view for an AC Gen-set application 300, in accordance with 3-port power conversion system 200. As depicted in this exemplary embodiment, first input portal 202 can include an asynchronous AC port such as a Gen-set, second input portal 204 can include a DC generator or storage port such as a photovoltaic array or batteries, and output portal 208 can include an AC power grid.

According to an exemplary embodiment, second input portal 204 includes a DC storage port such as one or more batteries. Asynchronous AC from first input portal 202 can be transformed into synchronous AC by power converter 206, and subsequently stored in second input portal 204 through power converter 206. Normally, this occurs when production from first input portal 202 exceeds consumption from a coupled grid, energy can be stored in a DC port from second input portal 204, or the power converter 206 can be operated by a control circuit to provide a DC power signal to charge batteries at second input portal 204. When consumption from a coupled grid exceeds production from first input portal 202, energy can be supplied by second input portal 204 to level with peak voltage demand, optimizing power generation from first input portal 202. The power converter 206 can transform the DC power supplied from second input portal 204 into synchronous AC.

In a second exemplary embodiment, second input portal 204 includes a DC generator such as a photovoltaic array. In this exemplary embodiment, output portal 208 can supply energy to a micro-grid (not shown in this figure) by using energy from second input portal 204, and first input portal 202.

According to yet another exemplary embodiment, one or more batteries or photovoltaic array in second input portal 204 can be used for dynamic braking of a Gen-set from first input portal 202, during a grid or micro-grid power outage. If neither a battery or PV array is attached, a resistor bank can be used for dynamic braking.

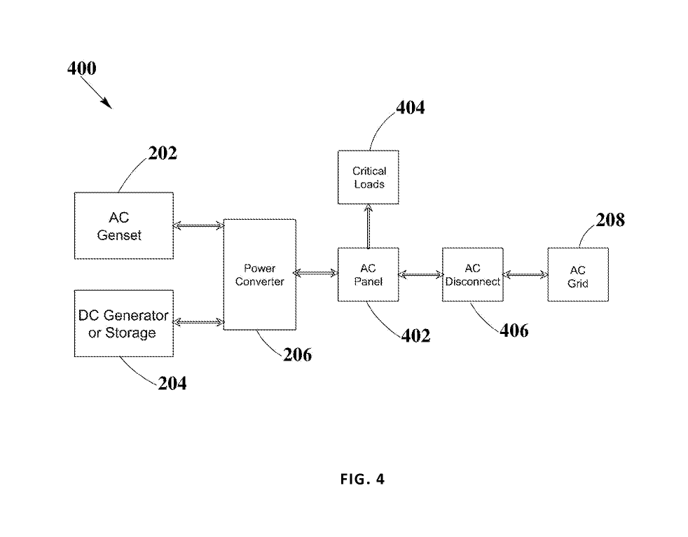

FIG. 4 shows a schematic view for an AC Gen-set application connected to a micro-grid 400, in accordance with 3-port power conversion system 200. As depicted, AC Gen-set application connected to a micro-grid 400 can include first input portal 202, second input portal 204, power converter 206, AC panel 402, critical loads 404, AC disconnect 406, and output portal 208. In this exemplary embodiment, first input portal 202 can include an asynchronous AC port such as a Gen-set, second input portal 204 can include a DC generator or storage port such as a photovoltaic array, batteries or a resistor bank, and output portal 208 can include an AC power grid.

According to the present exemplary embodiment, AC panel 402 can be connected to output portal 208 by AC disconnect 406. During grid faults from output portal 208, AC disconnect 406 can be switched to open position, and therefore, first input portal 202, and second input portal 204 can provide power for critical loads 404. Furthermore, according to one exemplary embodiment, AC Gen-set (e.g., via diesel or propane generators) can provide additional power to a DC generator or storage device from second input portal 204, thus, allowing second input portal 204 to reach maximum efficiency.

According to a different exemplary embodiment, one or more batteries or photovoltaic array in second input portal 204 can be used for dynamic braking of a Gen-set from first input portal 202, during a grid or micro-grid power outage.

### EXAMPLES

In example #1 more than one power converter is used to feed a critical load such as a hospital or an airport. In one exemplary embodiment, an AC Gen-set (e.g., via diesel or propane generators) and a DC storage (batteries) can be connected to a first input portal 202 and second input portal 204 of a first power converter. In another exemplary embodiment, a DC generator (PV array) and a DC storage can be connected to a first input portal 202 and a second input portal 204 of a second power converter.

According to some but not necessarily all embodiments, there is provided: Systems and methods where a power-packet-switching converter is used to interface a synchronous AC connection (e.g. to the utility power grid, or to a microgrid) to a DC source (e.g. a battery bank, or possibly a photovoltaic cell bank) and to a non-synchronous AC power source (e.g. a wind turbine or a motor-generator). The power-packet-switching converter not only provides voltage conversion and other functions (e.g. DC to AC, AC-AC with frequency change, 2-phase to 3-phase, power factor correction etc.), but also provides phase correction to convert asynchronous AC to synchronous AC.

According to some but not necessarily all embodiments, there is provided: A electrical power system, comprising: a multiport power converter, comprising a plurality of electrical ports, each having at least two lines, and an energy transfer reactance comprising an inductor and a capacitor in parallel, wherein each line of each said port is connected to multiple ends of said energy transfer reactance through multiple respective bidirectional switches; a battery bank connected to a first one of said ports; an AC power source connected to a second one of said ports; a third one of said ports being connected to supply power to an AC power grid or microgrid; wherein said AC power source does not operate synchronously with the AC power grid or microgrid; wherein said converter draws power from said first, second, and/or third ports, and drives power into said first and/or third ports, while changing the frequency and/or phase of power received at said second port to thereby provide power synchronously to said third port when needed.

According to some but not necessarily all embodiments, there is provided: A system for providing an uninterruptible power supply, comprising: a bidirectional multiport power converter, comprising: a plurality of input/output portals, each comprising one or more ports; an energy transfer reactance comprising an inductor and a capacitor in parallel, wherein each said port of each said input/output portal is connected in parallel to each end of the energy transfer reactance by a pair of bidirectional switching devices; wherein, at various times, the energy transfer reactance can be connected to two said ports, to transfer energy therebetween; and wherein, at various times, said energy transfer reactance can be disconnected from said input/output portals; an asynchronous AC power source connected to a first input/output portal of the bidirectional multiport power converter supplying converted synchronous AC power to an AC grid, said AC grid connected to a second input/output portal of said bidirectional multiport power converter; at least one DC power source connected to a third input/output portal of said bidirectional multiport power converter supplying converted synchronous AC power to said AC grid and said bidirectional multiport power converter operated to supply power from the at least one DC power source when consumption from said AC grid exceeds production from said first input/output portal to level with peak voltage demand thus optimizing power generation from said first input/output portal; and wherein said AC power source comprises a combustion engine-driven generator operated to supply converted synchronous AC power to said AC grid.

According to some but not necessarily all embodiments, there is provided: A method for providing an uninterruptible power supply, comprising: using a bidirectional multiport power converter, comprised of: a plurality of input/output portals, each comprising one or more ports; an energy transfer reactance comprising an inductor and a capacitor in parallel, wherein each of the ports of each of the input/output portals is connected in parallel to each end of the energy transfer reactance by a pair of bidirectional switching devices; wherein, at various times, the energy transfer reactance can be connected to two of the ports, to transfer energy there between; and wherein, at various times, the energy transfer reactance can be disconnected from the input/output portals; connecting an asynchronous AC power source to a first input/output portal of the bidirectional multiport power converter supplying converted synchronous AC power to an AC grid, the AC grid connected to a second input/output portal of the bidirectional multiport power converter; connecting at least one DC power source to a third input/output portal of the bidirectional multiport power converter supplying converted synchronous AC power to the AC grid; controlling the bidirectional multiport power converter to transfer power from the at least one DC power source when consumption from the AC grid exceeds production from first input/output portal to level with peak voltage demand thus optimizing power generation from first input/output portal; and wherein the AC power source comprises a combustion engine-driven generator operated to supply converted synchronous AC power to the AC grid.

According to some but not necessarily all embodiments, there is provided: An uninterruptible power supply system, comprising: a bidirectional multiport power converter, comprising: a plurality of input/output portals, each comprising one or more ports; an energy transfer reactance comprising an inductor and a capacitor in parallel, wherein each port of each of the input/output portal is connected in parallel to each end of the energy transfer reactance by a pair of bidirectional switching devices; wherein, at various times, the energy transfer reactance can be connected to two of the ports, to transfer energy there between; and wherein, at various times, the energy transfer reactance can be disconnected from the input/output portals; an AC power source connected to a first input/output portal of the bidirectional multiport power converter supplying converted synchronous AC power to an AC microgrid, the AC microgrid connected to a second input/output portal of the bidirectional multiport power converter; at least one DC power source connected to a third input/output portal of the bidirectional multiport power; wherein the AC microgrid comprises an AC panel coupled to the second input/output portal and connected to a critical loads and an AC disconnect, and an AC grid connected to the AC disconnect, the AC grid normally supplying power to the critical loads; and wherein the AC power source comprises a combustion engine-driven generator operated to supply converted synchronous AC power to the critical loads when critical loads power consumption exceeds power supplied by the AC grid.

According to some but not necessarily all embodiments, there is provided: A method for supplying an uninterruptible power, comprising: using a bidirectional multiport power converter, comprised of: a plurality of input/output portals, each comprising one or more ports; an energy transfer reactance comprising an inductor and a capacitor in parallel, wherein each of the ports of each of the input/output portals is connected in parallel to each end of the energy transfer reactance by a pair of bidirectional switching devices; wherein, at various times, the energy transfer reactance can be connected to two of the ports, to transfer energy there between; and wherein, at various times, the energy transfer reactance can be disconnected from the input/output portals; connecting an AC power source to a first input/output portal of the bidirectional multiport power converter supplying converted synchronous AC power to an AC microgrid, the AC microgrid connected to a second input/output portal of the bidirectional multiport power converter; wherein the AC microgrid comprises an AC panel coupled to the second input/output portal and connected to a critical loads and an AC disconnect, and an AC grid connected to the AC disconnect, the AC grid normally supplying power to the critical loads; and connecting at least one DC power source to a third input/output portal of the bidirectional multiport power converter; and controlling the bidirectional multiport power converter to transfer power from the AC power source when consumption from the AC microgrid exceeds production from the first input/output portal to level with peak voltage demand thus optimizing power generation from first input/output portal; and wherein the AC power source comprises a combustion engine-driven generator operated to supply converted synchronous AC power to the AC grid.

Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

Additional general background, which helps to show variations and implementations, as well as some features which can be implemented synergistically with the inventions claimed below, may be found in the following US patent applications. All of these applications have at least some common ownership, copendency, and inventorship with the present application, and all of them, as well as any material directly or indirectly incorporated within them, are hereby incorporated by reference: U.S. Pat. No. 8,406,265, U.S. Pat. No. 8,400,800, U.S. Pat. No. 8,395,910, U.S. Pat. No. 8,391,033, U.S. Pat. No. 8,345,452, U.S. Pat. No. 8,300,426, U.S. Pat. No. 8,295,069, U.S. Pat. No. 7,778,045, U.S. Pat. No. 7,599,196, US 2012-0279567 A1, US 2012-0268975 A1, US 2012-0274138 A1, US 2013-0038129 A1, US 2012-0051100 A1, Ser. Nos. 14/182,243, 14/182,236, PCT/US14/16740, Ser. Nos. 14/182,245, 14/182,246, 14/183,403, 14/182,249, 14/182,250, 14/182,251, 14/182,256, 14/182,268, 14/183,259, 14/182,265, 14/183,415, 14/182,280, 14/183,422, 14/182,252, 14/183,245, 14/183,274, 14/183,289, 14/183,309, 14/183,335, 14/183,371, 14/182,270, 14/182,277, 14/207,039, 14/209,885; U.S. Provisionals 61/765,098, 61/765,099, 61/765,100, 61/765,102, 61/765,104, 61/765,107, 61/765,110, 61/765,112, 61/765,114, 61/765,116, 61/765,118, 61/765,119, 61/765,122, 61/765,123, 61/765,126, 61/765,129, 61/765,131, 61/765,132, 61/765,137, 61/765,139, 61/765,144, 61/765,146 all filed Feb. 15, 2013; 61/778,648, 61/778,661, 61/778,680, 61/784,001 all filed Mar. 13, 2013; 61/814,993 filed Apr. 23, 2013; 61/817,012, 61/817,019, 61/817,092 filed Apr. 29, 2013; 61/838,578 filed Jun. 24, 2013; 61/841,618, 61/841,621, 61/841,624 all filed Jul. 1, 2013; 61/914,491 and 61/914,538 filed Dec. 11, 2013; 61/924,884 filed Jan. 8, 2014; 61/925,311 filed Jan. 9, 2014; 61/928,133 filed Jan. 16, 2014; 61/928,644 filed Jan. 17, 2014; 61/929,731 and 61/929,874 filed Jan. 21, 2014; 61/931,785 filed Jan. 27, 2014; 61/932,422 filed Jan. 28, 2014; and 61/933,442 filed Jan. 30, 2014; and all priority applications of any of the above thereof, each and every one of which is hereby incorporated by reference.

The claims as filed are intended to be as comprehensive as possible, and NO subject matter is intentionally relinquished, dedicated, or abandoned.

1-29. (canceled)

30. A method for supplying an uninterruptible power, comprising:
using a bidirectional multiport power converter, comprised of:
a plurality of input/output portals, each comprising one or more ports;
an energy transfer reactance comprising an inductor and a capacitor in parallel, wherein each of the ports of each of the input/output portals is connected in parallel to each end of the energy transfer reactance by a pair of bidirectional switching devices;
wherein, at various times, the energy transfer reactance can be connected to two of the ports, to transfer energy there between; and
wherein, at various times, the energy transfer reactance can be disconnected from the input/output portals;
connecting an AC power source to a first input/output portal of the bidirectional multiport power converter supplying converted synchronous AC power to an AC microgrid, the AC microgrid connected to a second input/output portal of the bidirectional multiport power converter;
wherein the AC microgrid comprises an AC panel coupled to the second input/output portal and connected to a critical loads and an AC disconnect, and an AC grid connected to the AC disconnect, the AC grid normally supplying power to the critical loads; and
connecting at least one DC power source to a third input/output portal of the bidirectional multiport power converter; and
controlling the bidirectional multiport power converter to transfer power from the AC power source when consumption from the AC microgrid exceeds production from the first input/output portal to level with peak voltage demand thus optimizing power generation from first input/output portal; and
wherein the AC power source comprises a combustion engine-driven generator operated to supply converted synchronous AC power to the AC grid.

31. The method for supplying uninterruptible power of claim 30, further comprising:
controlling the bidirectional multiport power converter to transfer converted synchronous AC power to the AC microgrid from the at least one DC power source when the AC power source is supplying power to the AC microgrid, and consumption from the AC microgrid exceeds production from the first input/output portal, so as to level with peak voltage demand thus optimizing power generation from the first input/output portal.

32. The method for supplying uninterruptible power of claim 30, further comprising:
using a photovoltaic array as the DC power source, wherein the bidirectional multiport power converter transfers power to the photovoltaic array to provide dynamic braking of the combustion engine-driven generator from the first input/output portal during an AC microgrid power outage.

33. The method for supplying an uninterruptible power of claim 30, further comprising:
using a bank of batteries as the DC power source, wherein the bidirectional multiport power converter transfers power to the bank of batteries to provide dynamic braking of the combustion engine-driven generator from first input/output portal during an AC grid power outage.

34. The method for supplying an uninterruptible power of claim 30, further comprising:
a bank of batteries comprising the at least one DC power source, wherein the bidirectional multiport power converter transfers power from the combustion engine-driven generator to supply converted DC power and charge the bank of batteries.

35. The method for supplying an uninterruptible power of claim 30, further comprising:
switching AC disconnect to open position during AC grid faults to isolate the AC grid, with the first input/output portal used by the bidirectional multiport power converter to transfer converted synchronous AC power to the critical loads from the combustion engine-engine generator.

36. The method for supplying an uninterruptible power of claim 30, further comprising:
switching AC disconnect to open position during AC grid faults to isolate the AC grid, with third input/output portal used by bidirectional multiport power converter to transfer converted synchronous AC power to the critical loads from the at least one DC power source.

37. The method for supplying an uninterruptible power of claim 30, further comprising:
switching AC disconnect to open position during AC grid faults to isolate the AC grid, with the first input/output portal used by the bidirectional multiport power converter to transfer converted synchronous AC power to the critical loads from the AC power source; and
transferring converted synchronous AC power to the critical loads from the third input/output portal when power consumption from the critical loads exceeds production from the first input/output portal.

38. The method for supplying an uninterruptible power of claim 30, wherein the at least one DC power source comprises:
a bank of batteries; or
a photovoltaic array.
